(19) United States
(12) Patent Application Publication
(10) Pub. No.: US 2012/0165047 A1
(43) Pub. Date: Jun. 28, 2012

(54) Method and Apparatus for Responding to Communication Notifications

(75) Inventor: Andre Moacyr Dolenc, Espoo (FI)

(73) Assignee: NOKIA CORPORATION, Espoo (FI)

(21) Appl. No.: 12/976,924

(22) Filed: Dec. 22, 2010

(51) Int. Cl. H04W 4/12

(52) U.S. Cl. 455/466; 370/338

(57) ABSTRACT

An example approach is provided for determining one or more communication types and/or sources and providing one or more responses. At least one received communication is associated with at least one party. Further, at least one response is determined to the at least one communication. Furthermore, the at least one response is associated with one or more subsequent communications originating from the at least one party.

### BACKGROUND

Service providers and device manufacturers (e.g., wireless, cellular, etc.) are continually challenged to deliver value and convenience to consumers by, for example, providing compelling network and connectivity services. With the ready availability of such services, modern consumers often carry at least one, if not more, communication devices throughout the day. As a result, many consumers are essentially reachable by some form of communication device around the clock whether they be a at home, work, school, library, movies, restaurants, etc. Particularly with the many different modes of communication that are available (e.g., text messages, multimedia message, instant messages, emails, etc.), consumers are finding it difficult to find moments that are free from the interruptive aspects of some of the potential communications. As such, device manufacturers face significant technical challenges to providing mechanisms to allow ease of use and control of communication notifications on a device.

### SOME EXAMPLE EMBODIMENTS

Therefore, there is a need for an approach for determining one or more communication types and/or sources and providing one or more responses.

According to one embodiment, a method comprises receiving at least one communication associated with at least one party. The method also comprises determining at least one response to the at least one communication. The method additionally comprises associating the at least one response with one or more subsequent communications originating from the at least one party.

According to another embodiment, an apparatus comprising at least one processor, and at least one memory including computer program code for one or more programs, the at least one memory and the computer program code configured to, with the at least one processor, cause the apparatus, at least in part, to receive at least one communication associated with at least one party. The apparatus is also caused to determine at least one response to the at least one communication. The apparatus is further caused to associate the at least one response with one or more subsequent communications originating from the at least one party.

According to another embodiment, a computer-readable storage medium carrying one or more sequences of one or more instructions which, when executed by one or more processors, cause, at least in part, the apparatus to receive at least one communication associated with at least one party. The apparatus is also caused to determine at least one response to the at least one communication. The apparatus is further caused to associate the at least one response with one or more subsequent communications originating from the at least one party.

According to another embodiment, an apparatus comprises means for receiving at least one communication associated with at least one party. The apparatus also comprises means for determining at least one response to the at least one communication. The apparatus further comprises means for associating the at least one response with one or more subsequent communications originating from the at least one party.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-9, 21-29, and 44-46.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of using determining one or more communication types and/or sources and providing one or more responses, according to one embodiment;

FIG. 2 is a diagram of the components of user equipment, according to one embodiment;

FIG. 3 is a flowchart of a process for receiving and responding to one or more communications, according to one embodiment;

FIG. 4 is a flowchart of a process for activating one or more modes of operation and responding to one or more communications, according to one embodiment;

FIG. 5 is a flowchart of a process for transmission of information on mode of operation, according to one embodiment;

FIG. 6 is a flowchart of a process for determining communication type and responding to the communication, according to one embodiment;

FIGS. 7A-7D are diagrams of user interfaces utilized in the processes of FIG. 3-6, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for determining one or more communication types and/or sources and providing one or more responses. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As communication devices become more engrained in daily work and life, consumers are subject to increasing numbers of potential disruptions from communications that are received regardless of location, time and/or activity a user maybe involved in. For example, a user may be attending a meeting, reading a book, having dinner, private mood, etc., when a communication (e.g., a phone call) is received at the user device, which the user chooses not to answer by forwarding it to an answering service (e.g., voicemail) and/or respond via a predetermined response (e.g., preset text, greeting, etc.). However, the user may wish to employ a more dynamic, potentially simpler and/or ad-hoc method for responding to the communications based one or more criteria decided by the user instead of utilizing a standard profile available on the user device. Further, the user may wish to “train” the user device and/or one or more applications on how to provide a communication notification to the user and/or potentially provide a substantially automated response based on one or more criteria, for example, communication type, history, source/party, time, user location, user activity and the like. Furthermore, the method can be utilized to train the user device during near real-time communications. Moreover, the one or more user communication devices can operate with substantially same setting, profiles, modes (e.g., synchronized) so that the user may not need to individually manage one or more communication notifications on each device. The one or more devices can share and/or synchronize by directly communicating with each other (e.g., via near field communication (NFC), Bluetooth, etc.), via the communication network 105 and/or via the services platform 103.

It is noted that a communication comprises, at least in part, a communication request from one or more devices, one or more sources, one or more types and the like.

In one embodiment, the user receives on a user device one or more communications from one or more sources (parties), but decides not to respond to the one or more communications; subsequently the user receives one or more other communications from the same one or more sources, however, in this instance the user device does not provide any communication notifications to the user.

In one embodiment, the user receives on a user device one or more communications from one or more sources, but decides to reject the communications; subsequently the user receives one or more other communications from the same one or more sources and in this instance, the user device does not provide any communication notifications to the user and logs one or more records of the one or more communications in one or more communication history logs.

In one embodiment, the user receives on a user device one or more communications from one or more sources and the communications manager presents one or more notifications (e.g., sounds, lights, vibrations, etc.). The user decides to reject the communications and subsequently, the user receives one or more other communications of different types from the same one or more sources and in this instance, the communications manager does not provide any communication notifications to the user and logs one or more records of the one or more communications in one or more communication history logs. For example, a user, John, receives a phone call from a source/party, Mark, and decides to reject the call; subsequently John receives an instant message (IM) from Mark, but in this instance, the communications manager 109 does not present to John any communication notifications on the new IM communication from Mark. In another embodiment, subsequent communications from Mark do not cause any communication notifications by the communications manager.

In one embodiment, the user device is in a particular operating mode (e.g., private mode) when one or more communications are received from one or more sources and the communications manager presents one or more notifications (e.g., sounds, lights, vibrations, etc.). The user decides to reject the communications, but subsequently, the user receives one or more other communications of the same and/or different types from the same one or more sources; in this instance, the communications manager does not provide any communication notifications to the user and logs one or more records of the one or more communications in one or more communication history logs. While the user device is still the same operating mode (e.g., private mode), the user can initiate one or more communications to the same one or more sources, but any communications from the same one or more sources would cause no communications notifications at the user device. For example, a user device of a user, John, is in private mode while it receives a phone call from a source/party, Mark, but John decides to reject the call. Subsequently, John decides to call Mark while John's user device (e.g., phone) is still in private mode. Later, John's user device receives an IM from Mark, but in this instance, the communications manager 109 does not present to John any communication notifications on the new IM communication from Mark. In another embodiment, if John, while still in private mode, calls Mark it causes, at least in part, the communications manager to allow subsequent communication notifications from Mark to be presented to John.

In another embodiment, the user receives a communication from a source on a user device and decides to forward the communication to a message storage (e.g., voicemail, email, etc.) and subsequently receives one or more communications from the same source. The user device forwards the communication to a message storage. For example, a user can choose via a user interface option to forward the communication to a voicemail system.

In another embodiment, the user receives a communication from a source on a user device while utilizing one or more applications on the user device and decides to acknowledge the communication, but postpone a response. Notifications of one or more subsequent communications from the same or one or more other sources are presented to the user, but no further action is required by the user.

In another embodiment, the user receives one or more communications from a source, which the user decides to ignore. One or more subsequent communications from the same source are presented to the user if one or more user and/or one or more user device conditions and/or criteria are different than the criteria during the last communication from the same source.

In another embodiment, the user device presents one or more communication notifications from one or more sources based on user location. For example, one or more communications from a source can be presented to the user, forwarded to an answering service, forwarded to a message storage, ignored, rejected and the like.

In another embodiment, the user can modify method of response to one or more communications from one or more sources already in use by the user device. For example, one or more communications from one or more sources currently may be directed to a message storage without providing a communication notification to the user; however, the user can actively modify the response method to the one or more communications from the one or more sources.

In another embodiment, the user has at least two user devices. The user activates an operating mode on one of the at least two devices. Further, the other devices of the at least two devices synchronize with each other so that the communications manager on each device operates substantially same so that the user does not have to manage each device separately. In one embodiment, one of the at least two user devices cause the synchronization via NFC, via Bluetooth, via the communication network 105 and/or via the services platform 103. In another embodiment the communication network 105 and/or the services platform 103 cause, at least in part, the synchronization of, at least, the communications manager of the at least two user devices. In another embodiment, the user causes, at least in part, the synchronization.

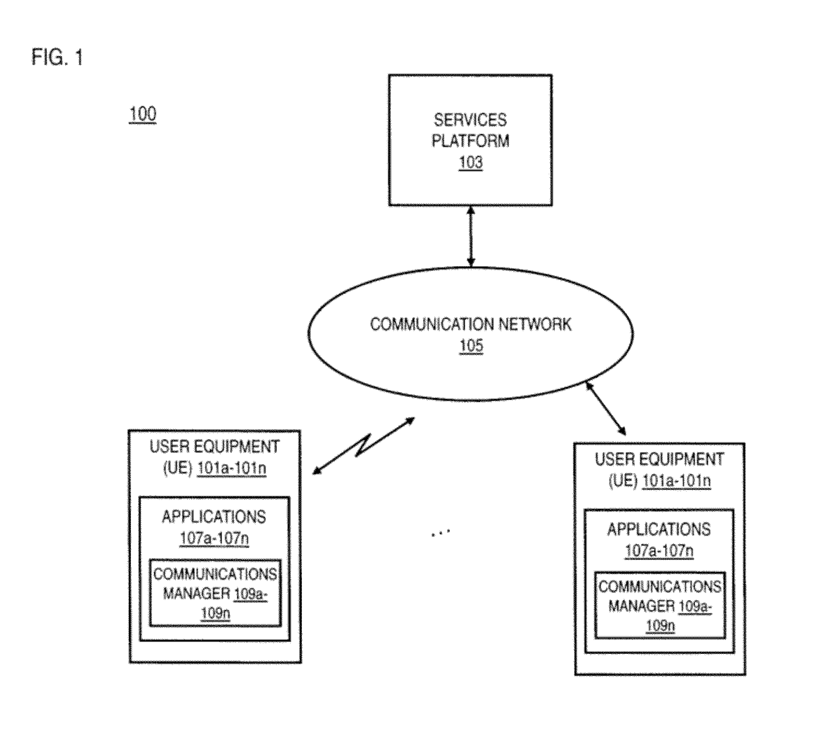

FIG. 1 is a diagram of a system capable of determining one or more communication types and/or sources and providing one or more responses. As previously noted users can receive one or more communications from one or more sources while the users are attending other tasks and may or may not wish to respond to the one or more communications. Further, the users may wish to respond to one or more communications from one or more sources while rejecting/ignoring one or more other communications from one or more sources. In order to achieve user desired functionality, the user may need to define and/or utilized one or more criteria for the one or more communication types and/or sources. However, such mechanisms may be complex, time consuming and/or require predefined profiles which the user may avoid utilizing.

To address this problem, a system 100 of FIG. 1 introduces the capability to determine one or more communication types and/or sources and provide one or more responses. In one embodiment, a user utilizes user equipment (UEs) 101a-101n (also collectively known as UEs 101) for communication with one or more other users and/or user devices over a communication network 105. Users may execute one or more applications 107a-107n (also collectively known as applications 107), for example one or more mapping applications, messaging applications, calendar applications, context applications, sensor applications and communications manager 109a-109n (also collectively known as communications manager 109). The services platform 103 can provide one or more services (e.g., location based services, mapping information, social networking services, etc.) to one or more users. Although various embodiments are described with respect to providing one or more responses to one or more communications, it is contemplated that the example approach described herein may be used with other types of services and/or applications.

As shown in FIG. 1, the system 100 comprises user equipment (UEs) 101a-101n having connectivity to a services platform 103 and/or to other UEs 101a-101n via a communication network 105. In one embodiment, a communication interface application facilitates the monitoring, coordination, organization, rendering, and/or generation of one or more communication notifications and/or responses. As noted previously, one or more communications may be received at the UEs 101 and one or more responses may be received from the user. The communications manager 109, via a user interface application, presents information on the one or more communications to the user, receives one or more responses from the user and/or provides one or more responses to the one or more communications. The communications manager 109 also facilitates the subsequent access and/or manipulation of one or more response criteria and any corresponding communications with one or more applications. (e.g., applications 107a-107n) executed by the UEs 101a-101n. In an embodiment, the communications manager 109 may initiate corresponding actions or functions provided by the applications 107, the services platform 103, and/or any other communications available over the communication network 105 related to one or more communications in various embodiments of the approach described herein.

In an example use case, a user, John, utilizes one or more communication devices to manage his social life and remain in touch with his colleagues at work. His successful career is largely due to his willingness to allow work to follow him 24/7. Now, he wishes to change his priorities and has decided to avoid work-related communications outside office hours and wants to differentiate and protect his private life. However, his extensive work-related network inside and outside the company are not aware of this change and moreover, John finds it difficult not to respond when someone tries to contact him. John has not found an effective way to shut out and/or limit the work-related intrusions while allowing family and friends to reach him during his private moments. From recent responses to communication from his colleagues, the communications manager 109 has “learned” that while John is at home, communications from John's colleagues, for example, are to be directed to a message storage, logged in a call log and notifications are to be presented to John when John is back at his office.

In one embodiment, the communications manager 109 receives one or more communications at the UEs 101 and provides one or more notifications to the user. For example, the one or more notifications can provide information on the one or more communications such as type (e.g., a voice call, an IM, an email, etc.), source (e.g., a family member, a friend, a colleague, etc.), priority (e.g., urgent, high, low, etc.) and/or the like. Further, the communications manager 109 may receive one or more responses from the user such as accept, reject, redirect or may receive no response (e.g., no action/ignore).

In another embodiment, the communications manager 109 receives one or more communications and provides one or more notifications substantially based on one or more past user responses. For example, in the past, the user rejected a call from a source therefore the communications manager 109 does not provide a communications notification to the user, bit logs a record of the communication.

In another embodiment, the communications manager 109 receives one or more communications from a source and provides one or more notifications to the user whereby the user forwards the communication to a message storage. Further, one or more subsequent communications from the same source are received whereby the communications manager 109 forwards the communication to a message storage.

In another embodiment, the communications manager 109 receives one or more communications and provides one or more notifications to the user while the user is utilizing one or more applications on the user device. Further, the user acknowledges the communication notification but defers a response. Furthermore, while the user is utilizing one or more application on the user device, the communications manager 109 receives one or more subsequent communications from one or more sources whereby one or more communications notifications are presented to the user, but no action/response is required/expected from the user.

In another embodiment, the communications manager 109 receives one or more communications and whereby no notifications are presented to the user as the user has one or more criteria (e.g., quiet, private, no disturbance, etc.) active in the communications manager 109 and/or in one or more applications 107. For example, no notification alerts are provided (e.g., sound, visual, haptic, etc.)

In another embodiment, the user has rejected one or more communications from one or more sources. However, the communications manager 109 receives a communication from a source which the user has accepted one or more communications while in substantially same mode and, therefore, presents a communication notification to the user.

In another embodiment, the communications manager 109 presents user status information to one or more of user contacts. For example, the user status may indicate the user is in a meeting and preferred method of contact and/or communication is via voicemail.

In another embodiment, the communications manager 109 presents one or more preset responses (e.g., a text message) to indicate further information (e.g., I will call back in 1 hour) to one or more contacts and/or communication sources (e.g., spouse).

As shown in FIG. 1, the system 100 comprises UEs 101 having connectivity to other UEs 101, services platforms 103 and/or other network elements via the communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101 and services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the services platform 103 may interact according to a client-server model with the applications 107 of the UEs 101. According to the client-server model, a client process sends a message including a request to a server process, and the server process responds by providing a service (e.g., navigation, ordering, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

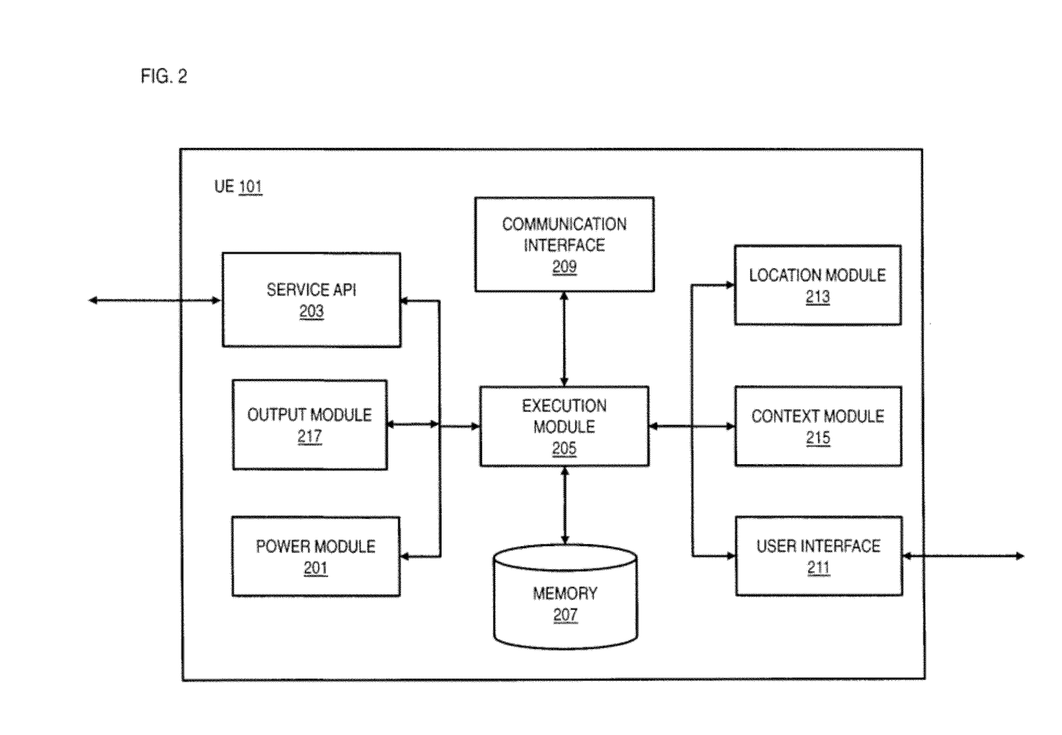

FIG. 2 is a diagram of the components of user equipment UEs 101, according to an embodiment. It is contemplated that the functions of these components may be combined in one or more components or performed by other components of equivalent functionality. In this embodiment, the UE 101 includes a power module 201 to provide power and power controls to the UE 101, service API 203, an execution module 205 to control the runtime of applications executing on the UE 101, a memory 207, a communication interface 209 to communicate over a network, a user interface 211 to output and receive input at the UE 101, a location module 213 to determine location information, a context module 215 and an output module, 217.

In one embodiment, the UE 101 includes a power module 201. The power module 201 provides power to the UE 101. The power module 201 can include any type of power source (e.g., battery, plug-in, etc.). Additionally, the power module 201 can provide power to the components of the UE 101 including processors and transmitters.

The communication interface 209 may include multiple means of communication. For example, the communication interface 209 may be able to communicate over SMS, internet protocol, instant messaging, voice sessions (e.g., via a phone network), or other types of communication. The communication interface 209 can be used by the execution module 205 to communicate with other UEs 101, the applications 107, services platform 103 and other devices. In some examples, the communication interface 209 is used to transmit information (e.g., service request information, user status information, etc.) to the services platform 103 and the like.

In one embodiment, a UE 101 includes a user interface 211. The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 211 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 211 may be utilized to present one or more communication types and/or sources and provide one or more responses status information as to the status of one or more service requests.

In one embodiment, UEs 101 include a location module 213. This location module 213 can determine a user's location. The user's location can be determined by a triangulation system such as Global Positioning System (GPS), Assisted GPS (A-GPS), Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 213 may also utilize multiple technologies to detect the location of the UE 101. GPS coordinates can provide finer detail as to the location of the UE 101 when media is captured. The runtime module 205 can also extrapolate addresses from the information gathered from the location module 213.

In one embodiment, a UE 101 has a context module 215. The context module 215 can obtain contextual information about a user of the UE 101. In one example, the context module 215 can retrieve location data of the user from the location module 213. In another example, the context module 215 can retrieve temporal data (e.g., a contact's birthday or a calendar entry) about a target object. In a further example, the context module 215 can obtain other context data or content data about the target object.

In certain embodiments, the communications manager 109 may run on the execution module 205. The communications manager 109 may utilize the user interface 211 to receive information regarding one or more communication types and/or sources and to provide one or more responses. Further, this information may be transmitted via the communication interface 209 to the user interface 211, the applications 107 and/or the services platform 103. Moreover, the information may be utilized by the applications 107, communications manager and/or services platform 103 to alert the user about one or more communications. This information may be stored in the memory 207 until utilized. The communications manager 109 then returns one or more responses from the user and/or the user device UEs 101 via the output module 217 and the service application programming interface (API) 201.

In one embodiment, the output module 217 facilitates a creation and/or a modification of at least one device user interface element, at least one device user interface functionality, or a combination thereof based, at least in part, on information, data, messages, and/or signals resulting from any of the processes and or functions of the communications manager 109 and/or any of its components or modules. By way of example, a device user interface element can be a display window, a prompt, an icon, and/or any other discrete part of the user interface presented at, for instance, the UEs 101. In addition, device user interface functionality refers to any process, action, task, routine, etc. that supports or is triggered by one or more of the user interface elements. For example, user interface functionality may enable speech to text recognition, haptic feedback, and the like. Moreover, it is contemplated that the output module 217 can operate based at least in part on processes, steps, functions, actions, etc. taken locally (e.g., local with respect to a UE 101) or remotely (e.g., over another component of the communication network 105 or other means of connectivity).

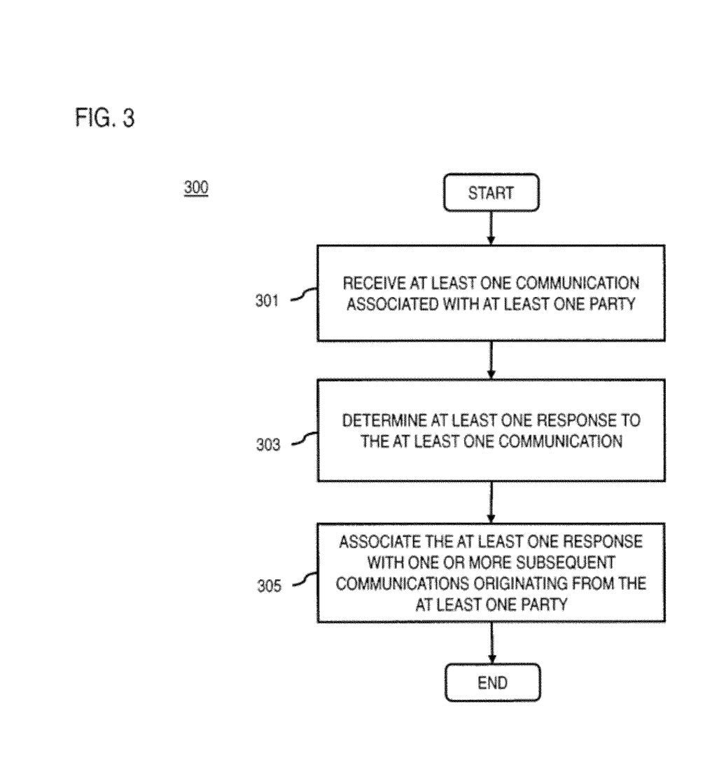

FIG. 3 is a flowchart of process 300 for receiving and responding to one or more communications, according to one embodiment.

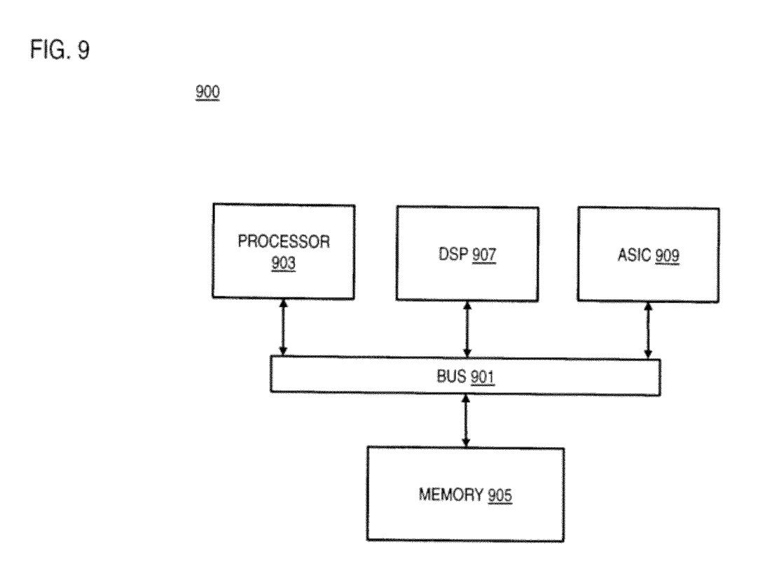

In one embodiment, communications manager 109 (e.g., executing on a runtime module 205) performs the process 300 and is implemented in, for instance, a chip set including a processor and a memory as shown in FIG. 9. Additionally or alternatively, one or more portions of the process 300 can be implemented via another device (e.g., the services platform 103), one or more other software modules, a combination thereof, etc. As such, the communications manager 109 and/or other devices/applications can be utilized as means for implementing one or more steps of the process 300.

At step 301, the communications manager 109 receives at least one communication associated with at least one party. In one embodiment, one or more communications from one or more sources are received at the UEs 101. For example, a voice call is received at a UE 101 indicating the source of the communication is a friend listed in the contact list of the UE 101. In an example use case, the UEs 101 receives a phone call from a source and the communications manager 109 causes, at least in part, one or more notifications (e.g., audio alert (ringing), flashing display, flashing light, vibrations, etc.) Further, the communications manager 109 may utilize one or more notification methods based, at least in part, on the type of received communication (e.g., voice, email, IM, SMS, etc.), UEs 101's capabilities, user defined criteria, history of user usage and the like.

At step 303, at least one response is determined for the one or more communications. In one embodiment, the user redirects the call to a message storage (e.g., a voicemail). In another embodiment, the user does not provide a response whereby the communications manager 109 does not provide a response to the one or more communications. Furthermore, the communications manager 109 may utilize the communication type as, at least one, parameter for providing a response to a communication. For example, the user of the UE 101 may wish for the communications manager 109 to direct all received audio communications (e.g., a phone call) to a message storage system such as a voice mail; however, an auto reply (e.g., “I will reply in one hour”) shall be sent to all received SMS communications.

At step 303, the communications manager 109 associates the at least one response with one or more subsequent communications originating from the at least one party. In one embodiment, the communications manager 109 associates a substantially same response to subsequent communication based on communication type, source, use location, user device activity, user selected mood and the like. For example, a communication is received at the UE 101 and the communications manager 109, at least in part, determines the type, source, priority and the like, associated with the communication. Further, the communications manager 109 determines that a previous communication (e.g., a phone call) received from the same source was rejected and/or directed to a message storage system (e.g., voice mail). Furthermore, in the above example, a subsequent communication from the same source is rejected.

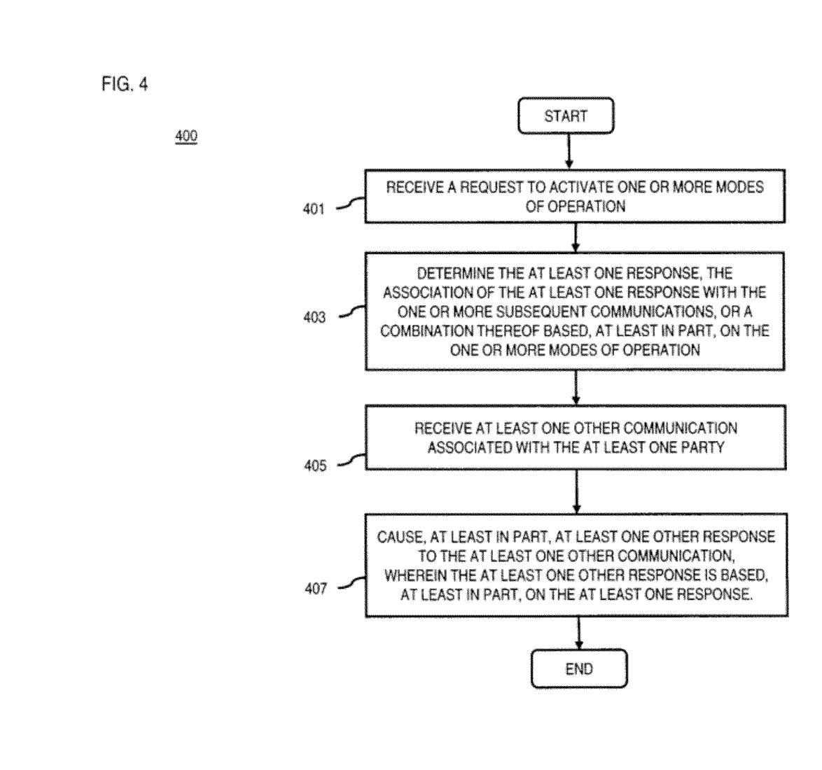

FIG. 4 is a flowchart of process 400 for activating one or more modes of operation and responding to one or more communications, according to one embodiment.

In one embodiment, communications manager 109 (e.g., executing on a runtime module 205) performs the process 400 and is implemented in, for instance, a chip set including a processor and a memory as shown in FIG. 9. Additionally or alternatively, one or more portions of the process 400 can be implemented via another device (e.g., the services platform 103), one or more other software modules, a combination thereof, etc. As such, the communications manager 109 and/or other devices/applications can be utilized as means for implementing one or more steps of the process 400.

At step 401, the communications manager 109 receives a request to activate one or more modes of operation. In one embodiment, the user of UE 101 selects one or more modes of operation based on user location, user activity, user mood, user device status, communication network status and the like. For example, a mode of operation can indicate a private mode, a quiet mode, meeting mode, travel mode and the like. The one or more modes of operation may be used, at least in part, in determining one or more communication notifications to the user and/or in determining one or more responses to the one or more communications.

At step 403, the communications manager 109 determines the at least one response, the association of the at least one response with the one or more subsequent communications, or a combination thereof based, at least in part, on the one or more modes of operation. For example, the UE 101 receives a communication (e.g. a phone call), the user rejects the communication and communications manager 109, at least in part, directs the communication to a message storage system (e.g., a voicemail system). Further, one or more subsequent communications are received at the UE 101 and the communications manager 109 directs the communications to one or more message storage system whereby at least one example advantage in doing so may be that the user is interrupted by one or more communication notifications. In another example, the UE 101 receives a communication (e.g. an IM), the user rejects the communication and the communications manager 109, at least in part, determines a response to the communication (e.g., “will be available in 30 minutes”). Further, one or more additional communications are received at the UE 101 and the communications manager 109 determines one or more responses based, at least in part, on the previous response.

At step 405, at least one other communication associated with the at least one party is received. In one embodiment, one or more subsequent communications are received from the same party, for example, an email, an instant message (IM), a text message (SMS) and the like.

At step 407, the communications manager 109 causes, at least in part, at least one other response to the at least one other communication, wherein the at least one other response is based, at least in part, on the at least one response. In one embodiment, the response, at least in part, is based on a previous response according to the previous mode of operation, previous type of communication, previous source, previous mood of user and the like.

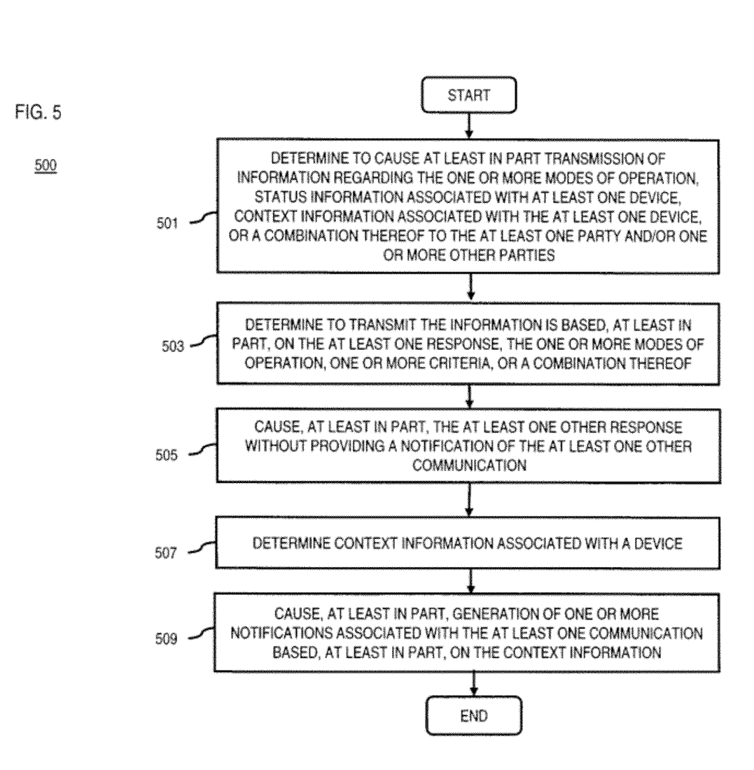

FIG. 5 is a flowchart of process 500 for transmission of information on mode of operation, according to one embodiment.

In one embodiment, communications manager 109 (e.g., executing on a runtime module 205) performs the process 500 and is implemented in, for instance, a chip set including a processor and a memory as shown in FIG. 9. Additionally or alternatively, one or more portions of the process 500 can be implemented via another device (e.g., the services platform 103), one or more other software modules, a combination thereof, etc. As such, the communications manager 109 and/or other devices/applications can be utilized as means for implementing one or more steps of the process 500.

At step 501, the communications manager 109 determines to cause, at least in part, transmission of information regarding the mode of operation, status information associated with at least one device, context information associated with the at least one device, or a combination thereof to the at least one party and/or one or more other parties. For example, the communications manager may send one or more information indicating that the user device is in “private-mode”; it is being utilized by the user to perform one or more tasks, for one or more applications and the like; user device network connectivity mode/condition and/or the like.

At step 503, transmission of the information is determined based, at least in part, on the at least one response, the mode of operation, one or more criteria, or a combination thereof. For example, the information can based on the device being in “quiet mode”, last user response was to reject a communication, user location, user device resources condition (e.g., battery life) and/or the like.

At step 505, the communications manager 109 causes, at least in part, the at least one other response without providing a notification of the at least one other communication. For example, a user has selected one or more auto responses to one or more recent communications and now, the communications manager 109 provides, at least in part, one or more auto responses to one or more subsequent communications without presenting any notifications to the user.

At step 507, context information associated with a device is determined. For example, one of more sensors on the user device, at least in part, may determine user device location (e.g., at home), user and/or user device activity (e.g., user device is updating an application, user is jogging, etc.), user device resources condition (e.g., low battery, poor network conditions, etc.), user mood (e.g., happy) and/or the like.

At step 509, the communications manager 109 causes, at least in part, generation of one or more notifications associated with the at least one communication based, at least in part, on the context information. For example, if the user is jogging, the communications manager 109 may provide that information to one or more communicating parties (e.g., predefined and/or otherwise). Further, if communications network condition are poor, the communications manager can postpone, reject, delay receiving one or more downloads (e.g., music, video, video call, etc.) from one or more sources. Furthermore, if the user is utilizing the user device for another application (e.g., playing a game, writing a report, viewing a video, etc.), the communications manager 109 can provide one or more responses to one or more communications.

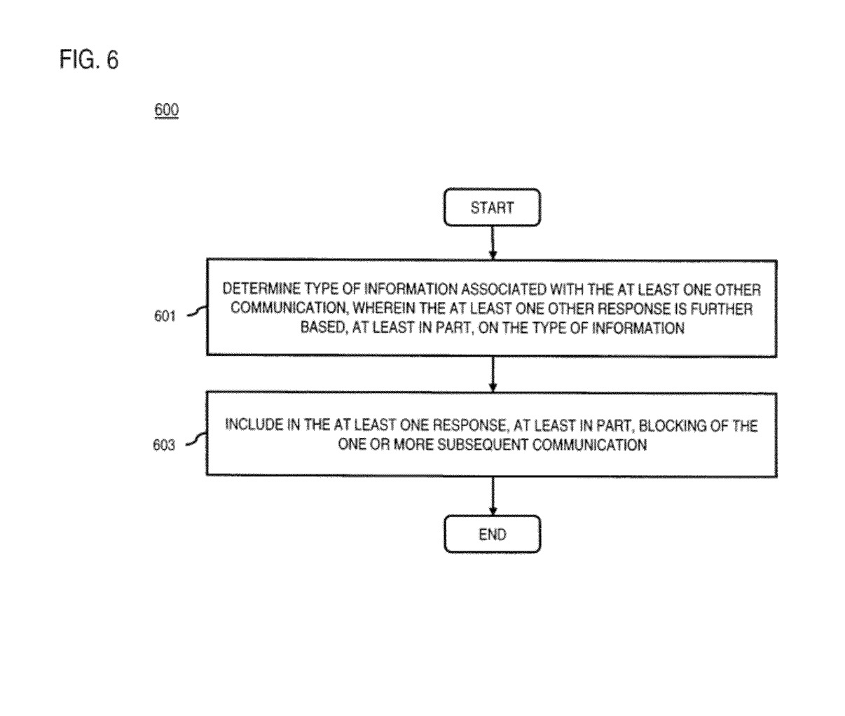

FIG. 6 is a flowchart of process 600 for determining communication type and responding to the communication, according to one embodiment.

In one embodiment, communications manager 109 (e.g., executing on a runtime module 205) performs the process 600 and is implemented in, for instance, a chip set including a processor and a memory as shown in FIG. 9. Additionally or alternatively, one or more portions of the process 600 can be implemented via another device (e.g., the services platform 103), one or more other software modules, a combination thereof, etc. As such, the communications manager 109 and/or other devices/applications can be utilized as means for implementing one or more steps of the process 600.

At step 601, type of information associated with the at least one other communication is determined, wherein the at least one other response is further based, at least in part, on the type of information. For example, the communications manager 109 can determine one or more information, such as communication source, ID number, type (e.g., email, audio call, IM, etc.) which may or may not be readily associated with a communication. In case where the information is not readily available the communications manager 109, at least in part, can request the information from, at least, the communication network 105, the services platform 103 and/or the like.

At step 603, blocking of the one or more subsequent communication, at least in part, is included in the at least one response. For example, one or more of the communications from one or more sources may be blocked on a user device based on one or more criteria (e.g., user device mode, user mood, user location, user profile, etc.)

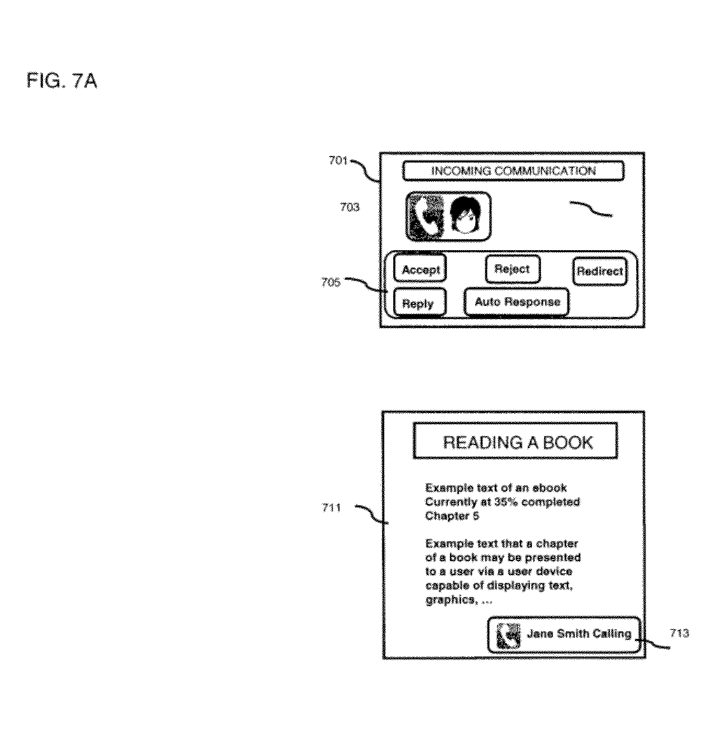

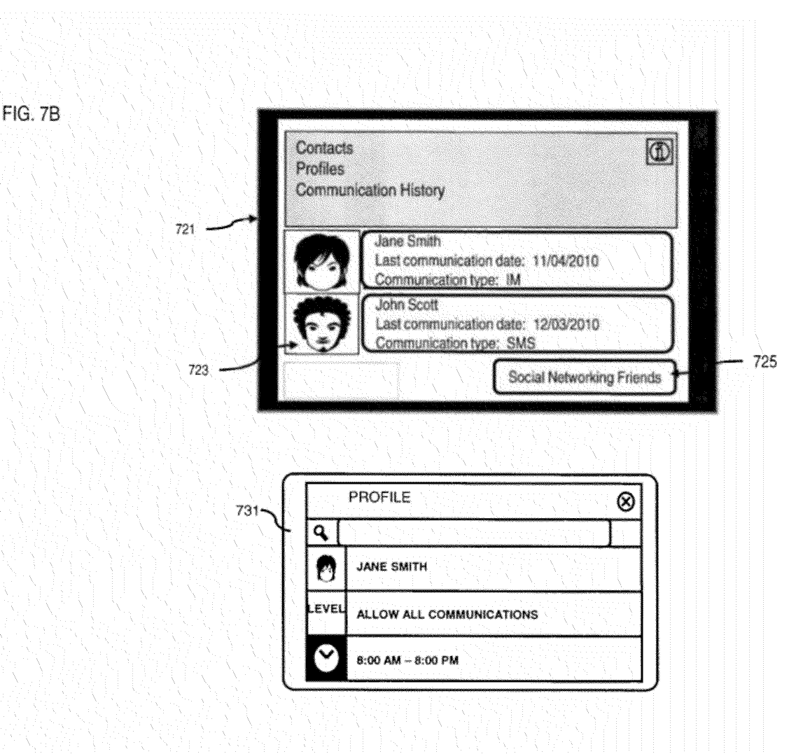

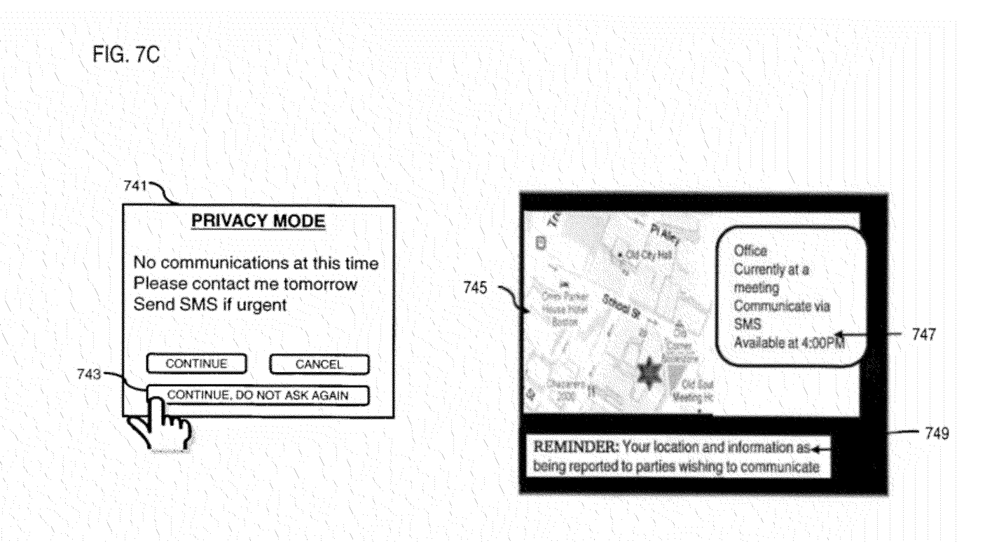

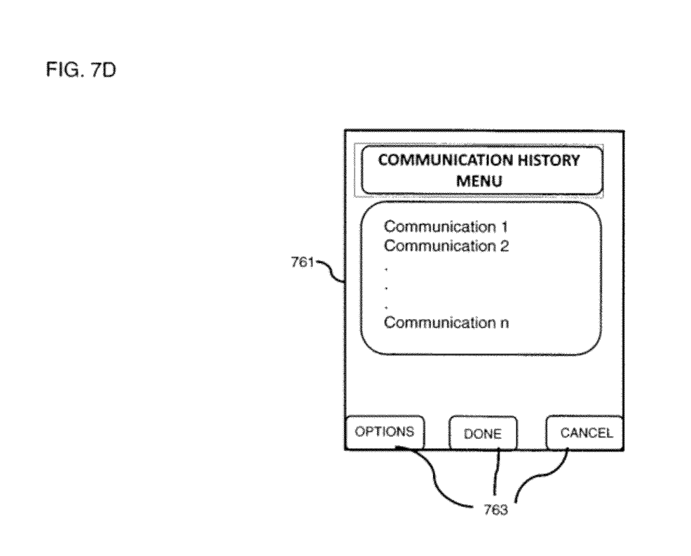

FIGS. 7A-7D are diagrams of user interfaces utilized in the processes of FIG. 3-6, according to various embodiments.

FIG. 7A depicts various user interfaces (UI) related to presentation of communication information at a user device. In one embodiment, UI 701 indicates a notification on an incoming communication at a user device. Indicator 703 indicates communication type (e.g., an audio/video call) including one or more source information (e.g., name, picture, etc.). Indicator 705 presents one or more options to the user to, for example, accept, reject, reply or redirect. Further, the user may select for one or more of the applications 107 on the UEs 101 to, at least in part, provide a response to the communication, which may be one or more types of responses (e.g., text, audio, etc.

FIG. 7B depicts UI related to user's contact information (e.g., a phone book). Indicator 721 shows a list of contacts with one or more information, for example, contact information, communication history, communication type, associated group 725 (e.g., social networking friends), picture 723 and/or the like. Further, 731 presents one or more information detail on a contact whereby the user may further define additional information related to the contact, for example, priority level, communication types, applicable time and/or a range of time and the like.

FIG. 7C depicts additional UI for presenting one or more user information to one or more other users. UI 741 indicates the user is in a privacy mode and a predefined response message (e.g., text message) is presented to the user with options 709 to continue, cancel or continue and not be asked again. Further, indicator 745 presents to the user one or more information that may be, at least in part, included in one or more responses to one or more other users. Indicators 747 and 749 show, at least in part, the one or more information.

FIG. 7D depicts a communication history menu 761 presenting, at least, one or more information on one or more communications. For example, the one or more information may indicate one or more communications which were received, missed, rejected, accepted and the like. Further, the user may take one or more actions at least via 763.

The processes described herein for determining one or more communication types and/or sources and providing one or more responses may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

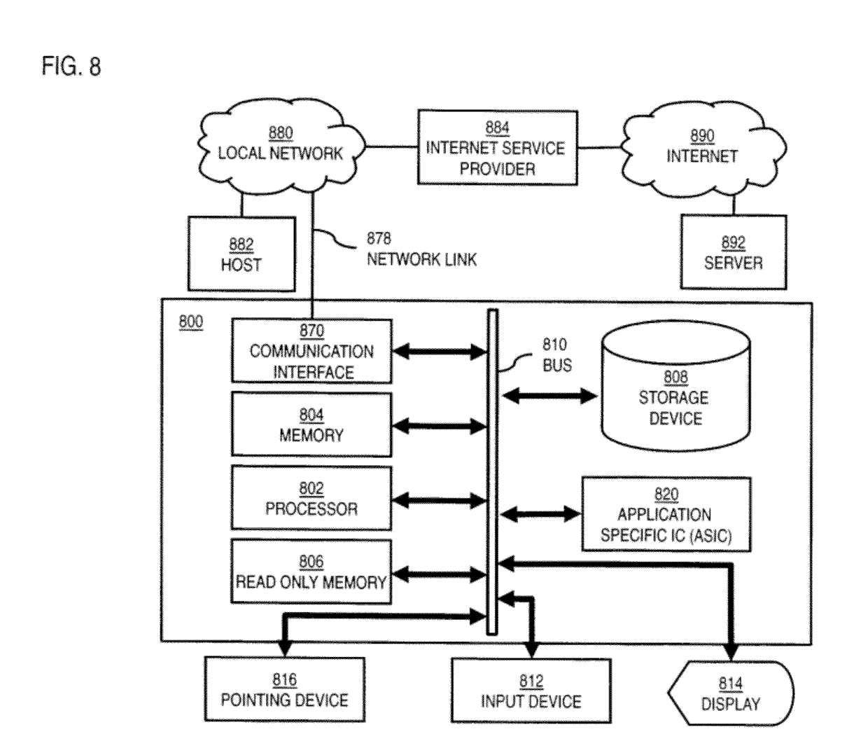

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to determine one or more communication types and/or sources and provide one or more responses as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of determining one or more communication types and/or sources and providing one or more responses.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to determine one or more communication types and/or sources and provide one or more responses. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for determining one or more communication types and/or sources and providing one or more responses. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for using determining one or more communication types and/or sources and providing one or more responses, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to determine one or more communication types and/or sources and provide one or more responses as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of determining one or more communication types and/or sources and providing one or more responses.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine one or more communication types and/or sources and provide one or more responses. The memory 905 also stores the data associated with or generated by the execution of the inventive steps.

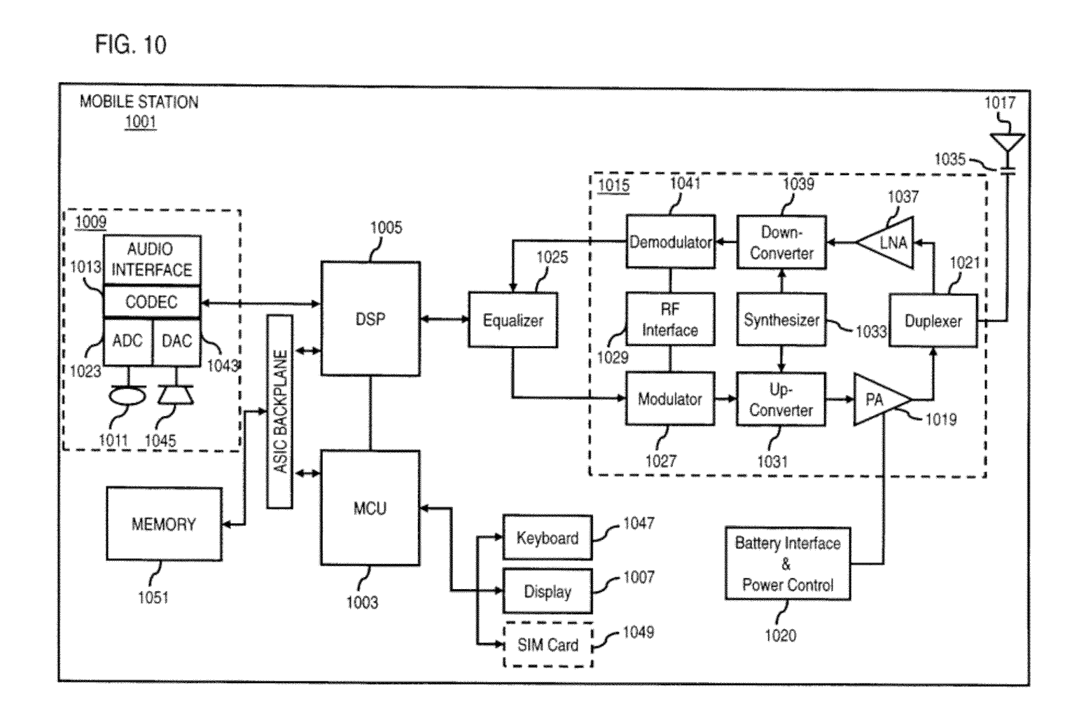

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of determining one or more communication types and/or sources and providing one or more responses. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of determining one or more communication types and/or sources and providing one or more responses. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to determining one or more communication types and/or sources and providing one or more responses. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one communication associated with at least one party;
at least one determination of at least one response to the at least one communication; and
at least one association of the at least one response with one or more subsequent communications originating from the at least one party.

2. A method of claim 1, wherein the (1) data and/or (2) information and/or (3) at least one signal are further based, at least in part, on the following:
at least one request to activate one or more modes of operation,
wherein the determination of the at least one response, the association of the at least one response with the one or more subsequent communications, or a combination thereof is based, at least in part, on the mode of operation.

3. A method of claim 1, wherein the (1) data and/or (2) information and/or (3) at least one signal are further based at least in part on the following:
at least one other communication associated with the at least one party; and
at least one determination to cause, at least in part, at least one other response to the at least one other communication,
wherein the at least one other response is based, at least in part, on the at least one response.

4. A method of claim 3, wherein the (1) data and/or (2) information and/or (3) at least one signal are further based, at least in part, on the following:
at least one determination to cause at least in part transmission of information regarding the mode of operation, status information associated with at least one device, context information associated with the at least one device, or a combination thereof to the at least one party and/or one or more other parties.

5. A method of claim 4, wherein the determining to transmit the information is based, at least in part, on the at least one response, the mode of operation, one or more criteria, or a combination thereof.

6. A method of claim 3, wherein the causing, at least in part, of the at least one other response is performed without providing a notification of the at least one other communication.

7. A method of claim 3, wherein the (1) data and/or (2) information and/or (3) at least one signal are further based, at least in part, on the following:
at least one determination of context information associated with a device; and
at least one determination to cause, at least in part, generation of one or more notifications associated with the at least one communication based, at least in part, on the context information.

8. A method of claim 3, wherein the (1) data and/or (2) information and/or (3) at least one signal are further based, at least in part, on the following:
at least one determination of type information associated with the at least one other communication,
wherein the at least one other response is further based, at least in part, on the type information.

9. A method of claim 1, wherein the at least one response includes, at least in part, blocking of the one or more subsequent communications.

10. An apparatus comprising:
at least one processor; and
at least one memory including computer program code for one or more programs,
the at least one memory and the computer program code configured to, with the at least one processor, cause the apparatus to perform at least the following,
receive at least one communication associated with at least one party;
determine at least one response to the communication; and
associate the at least one response with one or more subsequent communications originating from the at least one party.

11. An apparatus of claim 10, wherein the apparatus is further caused, at least in part, to:
receive a request to activate one or more modes of operation,
wherein the determination of the at least one response, the association of the at least one response with the one or more subsequent communications, or a combination thereof is based, at least in part, on the mode of operation.

12. An apparatus of claim 10, wherein the apparatus is further caused, at least in part, to:
receive at least one other communication associated with the at least one party; and
cause, at least in part, at least one other response to the at least one other communication,
wherein the at least one other response is based, at least in part, on the at least one response.

13. An apparatus of claim 12, wherein the apparatus is further caused, at least in part, to:
determine to cause at least in part transmission of information regarding the mode of operation, status information associated with at least one device, context information associated with the at least one device, or a combination thereof to the at least one party and/or one or more other parties.

14. An apparatus of claim 13, wherein the determination to transmit the information is based, at least in part, on the at least one response, the mode of operation, one or more criteria, or a combination thereof.

15. An apparatus of claim 12, wherein the causing, at least in part, of the at least one other response is performed without providing a notification of the at least one other communication.

16. An apparatus of claim 12, wherein the apparatus is further caused, at least in part, to:
determine context information associated with a device; and
cause, at least in part, generation of one or more notifications associated with the at least one communication based, at least in part, on the context information.

17. An apparatus of claim 12, wherein the apparatus is further caused, at least in part, to:
determine type information associated with the at least one other communication,
wherein the at least one other response is further based, at least in part, on the type information.

18. An apparatus of claim 10, wherein the at least one response includes, at least in part, blocking of the one or more subsequent communications.

19. A computer-readable storage medium carrying one or more sequences of one or more instructions which, when executed by one or more processors, cause an apparatus to at least perform the following:
receive at least one communication associated with at least one party;
determine at least one response to the communication; and
associate the at least one response with one or more subsequent communications originating from the at least one party.

20. A computer-readable storage medium of claim 19, wherein the apparatus is caused to further perform:
determine at least one update with respect to the at least one transaction, the one or more other transactions, or a combination thereof; and
determine to cause, at least in part, one or more actions for resulting in presentation of the at least one update at the one or more devices.

21.-46. (canceled)
